(19) United States
(12) Patent Application Publication
(10) Pub. No.: US 2020/0068928 A1
(43) Pub. Date: Mar. 5, 2020

(54) METHOD FOR MODULATING THE FLAVOR PROFILE OF A FOOD

(71) Applicant: INTERNATIONAL FLAVORS & FRAGRANCES INC., New York, NY (US)

(72) Inventor: Christopher E. Gibson, Dayton, NJ (US)

(21) Appl. No.: 16/613,218

(22) PCT Filed: May 14, 2018
(86) PCT No.: PCT/US2018/032491

§ 371 Date: Nov. 13, 2019

Related U.S. Application Data
(60) Provisional application No. 62/506,867, filed on May 16, 2017.

(51) Int. Cl. A23L 5/20; A23L 11/30; A23L 27/27; A23C 19/09; A23L 7/109

(52) U.S. Cl. CPC A23L 5/20; A23L 11/30; A23L 7/109; A23C 19/0925; A23L 27/27

(57) ABSTRACT

A method for modulating the flavor profile of a food by processing the food in the presence of one or more molecular sieves such as zeolites, activated carbon, molecular imprinted polymers or clay-based materials is described.

This application claims the benefit of priority from U.S. Patent Application Ser. No. 62/506,867, filed May 16, 2017, the contents of which is incorporated herein by reference in its entirety.

### BACKGROUND

Molecular sieve adsorbents are materials having pores or “cages” that adsorb water or other polar molecules. Often aided by strong ionic forces (electrostatic fields) due to the presence of cations such as sodium, calcium and potassium and large internal surface areas (e.g., in the range of 1000 m²/g), molecular sieves can adsorb a considerable amount of water and/or other compounds. If the molecule to be adsorbed is a polar compound, it can be adsorbed with high loading, even at very low concentrations of contaminants. Molecular sieves can therefore remove many gas or liquid impurities to very low levels (ppm or less). Another feature of molecular sieve adsorbents is their ability to separate gases or liquids by molecular size or polarity. The pore or “cage” openings of a particular molecular sieve are of the same size and can selectively separate chemically similar molecules; for example, in the case of hydrocarbon paraffins, normal, straight-chained molecules can fit into the pores and be adsorbed, while the branched molecules cannot enter the pores and pass through the molecular sieve bed un-adsorbed.

### SUMMARY OF THE INVENTION

The present invention provides a method for modulating the flavor profile of a food by processing the food in the presence of one or more molecular sieves which are capable of removing all or a portion one or more flavor compounds and optionally one or more toxic compounds. In some embodiments, the one or more molecular sieves comprise zeolites, activated carbon, molecular imprinted polymers or clay-based materials.

### DETAILED DESCRIPTION OF THE INVENTION

The present invention provides a method for using a molecular sieve or a combination of molecular sieves to modulate the flavor profile or flavor tonality of a food by removing or adsorbing all (100%) or a portion (e.g., 10%, 20%, 30%, 40%, 50%, 60%, 70%, 80%, 90% or 99%) of one or more flavor compounds and optionally one or more toxic compounds based upon size, hydrophobicity and/or charge of the flavors or toxic compounds. In accordance with the present method, one or more flavor compounds and optionally toxic compounds are removed by processing a food in the presence of one or more molecular sieves which are capable of removing one or more flavor and/or toxic compounds. Using this method, the flavor profile of a food can be tuned to be more or less bready, cheesy, smoky, earthy, astringent, floral, creamy, toasted, buttery, burnt, fruity, green, nutty, woody, musty, tart, estery, bitter, mealy, piney, soapy, metallic, fruity, grassy, ketonic, etc.

For the purposes of this invention, the term “processing” is intended to mean that the food product itself is contacted with the molecular sieve or one or more elements during food production are contacted with the molecular sieve, e.g., smoke, condensed smoke, water or other solvent. In certain embodiments, the term “processing” excludes the use of zeolites as catalysts for the conversion of one or more flavor compounds in a food to another flavor compound (e.g., conversion of α-pinene to p-cymene).

Molecular Sieves. Molecular sieves are crystalline substances with pores of molecular dimensions that permit the passage of molecules below a certain size. Conventionally, molecular sieves are based on an extensive three-dimensional network of oxygen ions containing generally tetrahedral-type sites. The term “molecular sieve” encompasses a variety of structures and types, and can include zeolitic molecular sieves and non-zeolitic molecular sieves such as zeolite-like sieves (e.g., germanium and tin-rich zeolite-type chalcogenides; Li, et al. (2014) J. Am. Chem. Soc. 137(19):6184), charcoal or clay-based materials. Zeolitic molecular sieves are typically aluminosilcates, but can also include aluminophosphates, gallophosphates and gallosilicates. In addition to the Si⁺⁴ and Al⁺³ of aluminosilcates, other cations can also be present. These cations need not be isoelectronic with Si⁺⁴ and Al⁺³, but have the ability to occupy framework sites. Cations known to occupy these sites within molecular sieve structures include, but are not limited to, (M⁺²O₂)⁻² where M is Be, Mg, Zn, Co, Fe, Mn; (M⁺³O₂)⁻¹ where M is Al, B, Ga, Fe, Cr; (M⁺⁴O₂)⁰ where M is Si, Ge, Mn, Ti; and ((M⁺⁵O₂)⁺¹ where M is P. See, e.g., Szostak (1989) Molecular Sieves, Principles of Synthesis and Identification, Van Nostrand Reinhold, New York, N.Y., pg 3. Zeolitic molecular sieves can be natural, synthetic, or a combination thereof. In addition, zeolitic molecular sieves can be de-aluminated, activated and/or chemically modified versions of natural or synthetic zeolitic molecular sieves.

Natural Molecular Sieves. Natural zeolites can be obtained from any source and include, but are not limited to, Analcime (|Na₁₆(H₂O)₁₆|[Si₃₂Al₁₆O₉₆], Cyclopean Islands, Greece); Afghanite (|Na_{17.4}K_{3.4}Ca_{10.7}) (SO₄)_{6.3}Cl_{5.7}F_{0.1}|[Si_{24.3}Al_{23.7}O₉₆], Pitigliano, Tuscany, Italy); Bikitaite |Li₂(H₂O)₂|[Si₄Al₂O₁₂], Bikita, Zimbabwe); Boggsite (|Na_{2.9}Ca_{7.8}(H₂O)₇₀|[Si_{77.5}Al_{18.3}O₁₉₂], Globe Area, Oreg.); Chabazite (|K_{3.2}Na_{0.75}(H₂O)_{8.4}|[Si_{8.2}Al_{3.8}O₂₄], Northeast Azerbaijan, Iran); Chiavennite (|Ca₄Mn₄(H₂O)₈|[Si₂₀(BeOH)₈O₅₂], Val di San Giacomo, Chiavenna, Italy); Edingtonite (|Ba₂(H₂O)₇|[Si₆Al₄O₂₀], Bathurst, New Brunswick, Canada); Epistilbite (|Na_{1.06}K_{0.1}Ca_{2.59}(H₂O)_{15.74}|[Si_{17.71}Al_{6.29}O₄₈], Teigarhorn, Iceland); Erionite, (|K_{2.02}Na_{1.94}Ca_{1.25}Mg_{0.63}(H₂O)_{10.4}|[Si_{26.16}Al_{9.31}Fe_{0.53}O₇₂], Wenatchee, Wash.); Farneseite (|(Na,K)₄₆Ca₁₀Cl_{10.48}(SO₄)_{8.54}(H₂O)_{12.6}|[Si₄₂Al₄₂O₁₆₈], Farnese, Viterbo Province, Italy); Faujasite (|Na_{28.8}Ca_{14.4}(H₂O)₂₆₃|[Si_{134.4}Al_{57.6}O₃₈₄], Kaiserstuhl, Germany); Ferrierite (|Na_{1.5}Mg₂(H₂O)₁₈|[Si_{30.5}Al_{5.5}O₇₂], Kamloops Lake, British Columbia, Canada); Franzinite (|Na_{20.56}K_{6.7}Ca_{11.7}(SO₄)₁₀Cl_{0.3}F_{0.1}(H₂O)₂|[Si_{29.8}Al_{30.2}O_{119.7}], Sacrofano, Latium, Italy); Gismondine (|Ca_{3.68}(H₂O)_{17.2}|[Si_{8.8}Al_{7.2}O₃₂], Hogenberg, Buhne, Westfalia); Amicite (|Na_{3.6}K_{3.76}(H₂)_{9.86}|[Si₁₈Al₈O₃₂], Hoewenneg, Hegau, Germany); Garronite (|Na_{0.8}Ca_{2.82}(H₂O)_{12.08}|[Si_{10.4}Al_{5.6}O₃₂], Goble, Oreg.); Gobbinsite (|Ca_{0.6}Na_{2.6}K_{2.2}(H₂O)₁₂|[Si₁₀Al₆O₃₂], Antrim District, Northern Ireland); Gmelinite (|Na₂, Ca)₄(H₂O)₂₄|[Si₁₅Al₈O₄₈], Nova Scotia, Canada); Goosecreekite (|Ca₂(H₂O)₁₀|[Si₁₂Al₄O₃₂], Loudon County, Va.); Heulandite (|Na_{0.1}K_{8.57}Ba_{0.04}(H₂O)_{19.56}|[Si_{26.83}Al_{9.31}O₇₂], Mossyrock Dam, Wash.); Clinoptilolite-K (|K,Na,Ca_{0.5}Sr_{0.5}Ba_{0.5}Mg_{0.5})₆(H₂O)₂₀|[Al₆Si₃₀O₇₂], Hoodoo Peak, Wyo.); Clinoptilolite-Na (|Na,K,Ca_{0.5}Sr_{0.5}Ba_{0.5}Mg_{0.5})₆(H₂O)₂₀|[Al₆Si₃₀O₇₂], San Bernardino County, Calif.); Clinoptilolite-Ca (|Ca_{0.5},Na,K,Sr_{0.5}Ba_{0.5}Mg_{0.5})₆(H₂O)₂₀|[Al₆Si₃₀O₇₂], Kuruma Pass, Japan); Laumontite (|Ca₄(H₂O)₁₈|[Si₁₆Al₈O₄₈], Naski, India); Leonhardite (|K_{0.1}Na_{0.3}Ca_{3.6}(H₂O)_{25.2}|[Si_{16.4}Al_{7.6}O₄₈], Teigahorn, Iceland); Levyne (|Ca_{8.19}Na_{1.95}K_{0.6}(H₂O)₅₀|[Si₃₅Al₁₉O₁₀₈], Sardinia, Italy); Liottite (|Na_{9.96}(K,Ca)_{8.04}Ca₆(SO₄)₅Cl_{3.5}F_{0.5}|[Si₁₈Al₁₈O₇₂], Tuscany, Italy); Lithosite (|K₁₂|[H₄Al₈Si₁₆O₅₂], Kola Peninsula, Russia); Lovdarite (|Na₁₂K₄(H₂O)₁₈|[Si₂₈Be₈O₇₂]; Lovezero Pluton, Russia); Perlialite (|K₁₂H₂O)₂₀|[Si₂₄Al₁₂O₇₂]; Murun Massif, Russia); Mazzite (|Na_{0.8}K_{2.5}Ca_{1.4}Mg_{2.1}(H₂O)₂₈|[Si_{26.5}Al_{9.9}O₇₂], Loire, France); Montesommaite (|Na_{0.1}K_{4.3}(H₂)₂₅|[Si_{11.3}Al_{4.7}O₃₂], Pollena, Italy); Mordenite (|Na₈(H₂O)₂₄|[Si₄₀Al₈O₉₆], Challis, Idaho); Nabesite (|Na_{6.96}K_{0.12}Ca_{0.04}(H₂)_{15.68}|[Si_{16.24}Be_{3.92}O₄₀], South Greenland); Natrolite (|Na₁₆(H₂O₁₆|[Si₂₄Al₁₆O₈₀], Aussig, Bohemia); Gonnardite (|Na_{6.42}K_{0.01}Ca_{1.5}(H₂)_{12.37}|[Si_{10.73}Al_{9.22}O₄₀], Tvedalen, Norway); Mesolite (|Na₁₆Ca₁₆(H₂O)₆₄|[Si₇₂Al₄₈O₂₄₀], Poona, India); Scolecite (|Ca₄(H₂O)₁₂|[Si₁₂Al₈O₄₀], Bombay, India); Gottardiite (|Na_{2.5}K_{0.2}Mg_{3.1}Ca_{4.9}(H₂O)₉₃|[Si_{117.2}Al_{18.8}O₂₇₂], Mt. Adamson, Antarctica); Partheite (|Ca₈(H₂O)₁₆|[Si₁₆Al₁₆O₆₀(OH)₈], Taurus Mountains, Turkey); Paulingite (|Na₁₃K₆₈Ca₃₆Ba_{1.5}(H₂O)₇₀₅|[Si₅₂₀Al₁₅₂O₁₃₄₄], Rock Island Dam, Wash.); Phillipsite (|K₂Ca_{1.7}Na_{0.4}(H₂)_{13.5}|[Si_{10.6}Al_{5.3}O₃₂], Rome, Italy); Tugtupite (|Na₈Cl₂|[Si₈Al₂Be₂O₂₄], South Greenland); Stilbite (|Na_{1.28}Ca_{4.18}Mg_{0.18}(H₂O)_{34.1}|[Si_{25.7}Al_{10.3}O₇₂], Iceland); Barrerite (|Na_{10.9}K_{2.1}Mg_{0.3}Ca_{1.7}(H₂O)_{51.6}|[Si_{55.6}Al_{16.4}O₁₄₄], Sardinia, Italy); Offretite (|Na_{0.1}K_{1.09}Mg_{1.11}Ca_{1.07}Sr_{0.01}Ba_{0.01}(H₂O)_{17.63}|[Al_{5.52}Si_{12.49}O₃₆], Adamello, Italy) Terranovaite (|Na_{4.2}K_{0.2}Mg_{0.2}Ca_{3.7}(H₂O)_{>29}|[Al_{12.3}Si_{67.7}O₁₆₀], Mt. Adamson, Antarctica) and combinations thereof. Ideally, the natural zeolite is thermally stable. In certain embodiments, the zeolite is Analcite, Clinoptilolite, Chabazite, Erionite, Mordenite, Offretite, Faujasite or a combination thereof.

In certain embodiments, the zeolite is Clinoptilolite. Clinoptilolite can be obtained from any location including, e.g., the United States, Italy, Japan, Bulgaria, Hungary, Cuba, Greece, UK, Mexico, Iran, Jordan, Slovakia or Russia. Depending on where the Clinoptilolite is sourced, it can contain additional components including, but not limited to, feldspars, clays, glass and quartz. Ideally, the additional components each constitute less than 10% of the Clinoptilolite composition.

Synthetic Molecular Sieves. Synthetic molecular sieves have several advantages over natural molecular sieves in that they are pure, composed of only one type, and are commercially available in virtually unlimited amounts often synthesized to a required pores size specification. Synthetic molecular sieves of use in this invention include, but not limited to, zeolite AG-2 (DE 2,248,626); zeolite Alpha (U.S. Pat. No. 3,375,205); zeolites AlPO₄-5, AlPO₄-9, AlPO₄-11, AlPO₄-12, AlPO₄-14, AlPO₄-15, AlPO₄-16, AlPO₄-17, AlPO₄-18, AlPO₄-20, AlPO₄-21, AlPO₄-22, and AlPO₄-23 described in U.S. Pat. No. 4,310,440; zeolite AlPO₄-H3; zeolite AlPO₄-12-TAMU ((1986) J. Phys. Chem. 90:6122); zeolite AlPO₄-H4 ((1961) Bull. Chem. Soc. Fr. 1762); zeolite BETA (U.S. Pat. No. 3,308,069); zeolite AlPO-EN3 (Kirchner, et al. (2000) Micro. Mesop. Mat. 39:319-332); zeolite B-SGT; zeolite BSD; zeolite C; zeolite EU-2; zeolite EU-4 (EP 63,436); zeolite LZ-105 (U.S. Pat. No. 4,257,885); zeolite LZ-132 (EP 91,048); zeolite ZSM-5 (U.S. Pat. No. 3,702,886); zeolite A (U.S. Pat. No. 2,882,243); zeolite X (U.S. Pat. No. 2,882,244); zeolite Y (U.S. Pat. No. 3,130,007); zeolite K-G (U.S. Pat. No. 3,055,654); zeolite ZK-5 (U.S. Pat. No. 3,247,195); zeolite ZK-4 (U.S. Pat. No. 3,314,752); zeolite Li-ABW (Anderson & Ploug-Sorensen (1986) Z. Kristallogr. 176:67-73); ACP-1 (Feng, et al. ((1997)Nature 388:735-41); zeolite ASU-7 (Li & Yaghi (1998) J. Am. Chem. Soc. 120:10569-70); zeolite MAPO-39 (Baur, et al. (1999) Z. Kristallog. 214:154-9); zeolite FOS-5 (Conradsson, et al. (2000) Micro. Mesop. Mat. 41:183-91); cancrinite (Smolin, et al. (1981) Kristallografiya 26:63-6); zeolite CDS-1; zeolite MCM-65 (Dorset & Kennedy (2004) J. Phys. Chem. B 108:15216-22); zeolite UZM-25; zeolite CIT-5 (Wagner, et al. (1997) J. Chem. Soc., Chem. Comm. 2179-80); zeolite SAPO-47 (Pluth & Smith (1989) J. Phys. Chem. 93:6515-20); zeolite CIT-1 (Lobo & Davis (1994) J. Am. Chem. Soc. 117:3766-79); zeolite ECR-34 (Strohmaier & Vaughan (2003) J. Am. Chem. Soc. 125:16035-9); zeolite EMM-3 (Afeworki, et al. (2006) Chem. Mater. 18:1697-1704); Siliceous Ferrierite ([Si₃₆O₇₂], Morris, et al. (1994) J. Am. Chem. Soc. 116:11849-55); zeolite Na-P1 (Baerlocher & Meier (1972) Z. Kristallogr. 135:339-54); zeolite GUS-1 (Plevert, et al. (2000) J. Chem. Soc., Chem. Commun. 2363-64); zeolite ITQ-12; zeolite ITQ-3; zeolite ITQ-24; zeolite ITQ-27; Losod (|Na₁₂(H₂O)₁₈|[Si₁₂Al₁₂O₄₈]); zeolite ZSM-11; zeolite ZSM-10; zeolite MCM-68; zeolite MCM-61; zeolite MCM-35; zeolite Dodecasil 3C; zeolite ZSM-12; zeolite NU-87 (Shannon, et al. (1991) Nature 353:417-20); zeolite OSB-2; zeolite Ui0-6; zeolite OSB-1; zeolite Ui0-28; zeolite RUB41 (Wang, et al. (2005) Chem. Mater. 17:43-9); zeolite RUB-13; zeolite RUB-10; zeolite RUB-24; zeolite STA-6; zeolite STA-2; zeolite STA-7; zeolites UCSB-6GaCo, UCSB-10GaZn and UCSB-8GaCo (Bu, et al. (1997) Science 278:2080-5); zeolite SSZ-48; zeolite SSZ-58; zeolite SSZ-53; zeolite SIZ-7; Bicchulite (|Ca₈(OH)₈|[Si₄Al₈O₂₄]); zeolite SU-16; zeolite SUZ-4; zeolite TNU-9; or a combination thereof. In some embodiments, the synthetic zeolite has a high ratio of silicon (e.g. at least 1:2, 1:3, 1:4, or 1:5 Al to Si ratio) thereby exhibiting a higher affinity for non-polar organics.

Thermal Activation. Thermal activation of zeolites can remove volatile intercalates (including water) and/or alter the framework elemental coordination of the zeolite. In general, thermal activation improves efficiency; the higher the temperature of activation, the higher the efficiency. Thermal activation can be achieved at temperatures in the range of 50° C. to 500° C., 100 ° C. to 400° C., or 150° C. to 300° C. While in some embodiments it may be desirable that the zeolite exhibits greater than 90% efficiency, e.g., in the removal of toxic components, in other embodiments efficiencies of less than 100% may be desired to selectively remove only a portion (e.g., 90%, 80%, 70%, 60%, 50%, 40%, 30%, 20%, or 10%) of a flavor compound to modify the taste profile of a food. Accordingly, efficiency of the zeolitic molecular sieves of this invention can be modulated by thermal activation.

Moisture content of a zeolitic molecular sieve can also modulate efficiency. In general, filtration efficiency decreases as water content increases. By way of illustration, 15% moisture content of a sodium aluminosilcate molecular sieve removes 100% acetaldehyde, whereas 20% moisture content removes 23% acetaldehyde. See GB 932,570. Accordingly, the moisture content of zeolitic molecular sieve can be modified to selectively remove only a portion (e.g., 90%, 80%, 70%, 60%, 50%, 40%, 30%, 20%, or 10%) of a flavor compound to modify the taste profile of a food. In some embodiments, the moisture content of the zeolitic molecular sieve is in the range of 0 to 25%, 0 to 20%, or 5 to 15%.

Surface Modification. Many unmodified natural zeolites are poor adsorbents of anionic compounds and, due to surface hydrophilics, are poor adsorbents of most organics as well. However, surface modification can change the surface functionality by adding cationic surfactants or other hydrophobic groups thus making zeolites applicable for adsorption of various anions and organics. Surface modifiers of use in this invention include, but are not limited to, hexadecyltrimethylammonium (HDTMA; Li, et al. (2000) Environ. Sci. Technol. 34:3756-60; Ozdemir, et al. (2004) Dyes Pigment 62:49-60; Jovanovic, et al. (2006) Recent Dev. Adv. Mater. Process 518:223-228; Bowman (2003) Micropor. Mesopor. Mater. 61:43-56), tetramethylammonium (TMA; Nikashina & Myaosedov (1999) Nat. Micropor. Mater. Environ. Techn. pg. 335-43), tetraethylammonium bromide (TEA; Sullivan, et al. (1998) J. Colloid Interf. Sci. 206:369-80), octadecyldimethylbenzylammonium (ODMBA; Dakovic, et al. (2003) Colloid. Surf. B Biointerfaces 30:157-65), stearyldimethylbenzylammonium (SDBA; Lemic, et al. (2006) Water Res. 40:1079-85), benzyltetradecyl ammonium (BDTDA; Kuleyin (2007) J. Hazard Mater. 144:307-15), cetylpyridinium bromide (CPB), octadecyltrimethylammonium (OTA; Xi, et al. (2005) Spectrochim. Acta Part A: Mol. Biomol. Spectre. 61:515-25; Schulze-Makuch, et al., (2002) EOS 83:193-201), ethylhexadecyldimethylammonium, 4-methylpyridinium (U.S. Pat. No. 7,311,839), benzyltrimethylammonium chloride (BTMA), cyclodextrins (Razee & Masujima (2002) Anal. Chim. Acta 464:1-5) and chlorosilanes (Huttenloch, et al. (2001) Environ. Sci. Technol. 35:4260-4).

Notably, the concentration of a surface modifier can modulate hydrophobic character. For example, water adsorption has been found to decrease with increasing SDBAC loading up to 75 mmol/kg, which is related to increasing sorbate hydrophobicity. Further, complete adsorption of polycyclic aromatic hydrocarbons (PAHs) is achieved with a monolayer of surfactant as compared to bilayer coverage. See Lemic et al. (2007) Micropor. Mesopor. Mat. 105:317-23. Accordingly, zeolitic molecular sieve efficiency can be further modified by concentration and coverage of zeolite particles with a surface modifier.

Ion Substitution. The chemical composition of zeolitic molecular sieves can be further manipulated by exchanging or intercalating into the zeolite framework a particular element or group of elements to imbue the zeolite with the required chemistry and/or efficiency. By way of illustration, treatment of paraquat effluent using Faujasite exchanged with Na, K, Ca and Mg has been compared. The Na and K loading gave better results compared to Ca and Mg (Ibrahim & Jbara (2009) J. Hazard. Mater. 163:82-86). Thus, zeolitic molecular sieves of this invention can be modified to include one or more of sodium, lithium, potassium, hydrogen, silver, ammonium, magnesium, calcium, zinc, barium, cerium, and/or manganese. Ion substitution or exchange can be affected by incubating the zeolitic molecular sieve in a solution including the desired ion. For example, incubation with sodium chloride, potassium chloride, ammonium chloride or CuSo₄ results in zeolitic molecular sieves comprising sodium, potassium, NH₄+, and copper, respectively.

pH. In addition to ion substitution and surface modification, sorption capacity of a zeolitic molecular sieve can be altered by modifying the pH of the sieve. For example, it has been shown that increasing pH from 3 to 11, decreases sorption of monomeric hydrocarbons by cationic surfactants-modified clinoptilote from 97 to 75% (Torabian et al. (2009) Clean Soil Air Water 38:77-83). Thus, zeolitic molecular sieve efficiency can be further modified by increasing or decreasing pH. In this respect, the pH of the molecular sieve can be approximately 2, 3, 4, 5, 6, 7, 8, 9, 10 or 11.

Particle/Pore Size. Fine materials have a greater area per unit of volume than coarse materials. In this respect, increasing zeolite particle size has been found to decrease adsorption efficiency (Bird, et al. (1933) Ind. Eng. Chem. 25:564; Lemic et al. (2007) Micropor. Mesopor. Mat. 105:317-23). Accordingly, zeolitic molecular sieve efficiency can be modulated by increasing or decreasing particle (bead or powder) size. In some embodiments, the particle size is in the range of 0.001 mm to 2 mm. In other embodiments, the particle size is in the range of 0.001 mm to 1 mm. In further embodiments, the particle size is in the range of 0.001 mm to 0.5 mm. In further embodiments, the particles are 2 to 40 mesh, 3 to 30 mesh or 4 to 25 mesh.

Pore diameter can also be selected to allow certain flavor compounds to pass through the molecular sieve while retaining other flavor compounds and/or selectively removing toxic compounds. For example, benzo[a]pyrene has a molecular length of about 14 Å. In this respect, a zeolite particle filter having pores sizes of less than 10 Å would be suitable for removing benzo[a]pyrene from a food and allowing smaller molecules to pass through. In certain embodiments, the pore diameter of zeolite particles is in the range of 0.1 Å to 22 Å, 0.5 Å to 15 Å, or 1 Å to 10 Å.

Non-Zeolitic Molecular Sieves. Non-zeolitic molecular sieves include other materials such as activated carbon, molecular imprinted polymers or clay-based materials that are capable of removing or adsorbing all or a portion of one or more flavor and/or toxic compounds. Similar to zeolitic molecular sieves, selectivity and efficiency of non-zeolitic molecular sieves can be modulated by thermal activation, surface modification, ion exchange, changes in pH, particle size and/or pore diameter.

Activated Carbon. Activated carbon is a powdered, granular or pelleted form of amorphous carbon characterized by very large surface area per unit volume because of an enormous number of fine pores. Activated carbon is capable of collecting gases, liquids, or dissolved substances on the surface of its pores. Adsorption on activated carbon is selective, favoring non-polar over polar substances. Compared with other commercial absorbents, activated carbon has a broad spectrum of adsorptive activity; excellent physical-, chemical- and thermo-stability, controllable pore structure and ease of the production from readily available, frequently waste materials. See, e.g., Chen, et al. (2010) Adv. Colloid Interface Sci. 163:39-52. Its chemical nature can also be easily modified by chemical treatment in order to enhance its properties. A number of carbonaceous raw materials can be used for the manufacture of activated carbon. Examples include, but are not limited to, wood, saw dust, cork, rice husk, peat, lignite, banana stalks, bamboo dust, nut shells (particularly coconut), coal, petroleum coke, and other residues in either granular, briqueted, or pelleted form are used for adsorbent products.

Activation is the process of treating the carbon to open an enormous number of pores in the 1.0 nm to 100 nm diameter range. After activation, the carbon has the large surface area (500-1500 m²/g) responsible for the adsorption phenomena. In some embodiments, the activated charcoal has a specific surface area exceeding a million square centimeters per gram. Carbons that have not been subjected previously to high temperatures are easiest to activate. Selective oxidation of the base carbon with steam, carbon dioxide, fuel gas, or air is one method of developing the pore structure. Activated carbon is a fine, black, odorless and tasteless powder, free from gritty matter with a powerful adsorption capacity to trap or chelate gases and particulate matter.

Molecular Imprinted Polymers. Molecularly imprinted polymers (MIPs) are a class of selective adsorbents. Molecularly imprinted polymers are polymers that are prepared in the presence of a template molecule leading to the formation of sites that are complementary to the template and can selectively bind the template and other functionally related molecules. Templates in the preparation of the molecularly imprinted polymer include the flavor compounds and/or toxic compound described herein.

Molecularly imprinted polymers can be composed any type of polymer or copolymer and in some embodiments, the molecularly imprinted polymer includes a polymer prepared from one or more monomers including, e.g., vinyl-containing monomers, acrylic acid or acrylate-containing monomers, acrylamide-containing monomers, and derivatives thereof. Particular monomers useful according to the invention include, but are not limited to, vinyl chloride, vinyl fluoride, vinylidene fluoride, methyl vinyl ether, perfluoro(methyl vinyl ether), chloroprene, isoprene, vinyl acetate, ethylene, acrylic acid, methacrylic acid, trifluoromethacrylic acid, methyl methacrylic acid, methyl methacrylate, ethylene glycol dimethacrylate, hydroxyethyl methacrylate, trans-3-(3-pyridyl)-acrylic acid, styrene, 4-ethyl styrene, p-vinyl benzoic acid, 4-vinylpyridine, 4-vinylbenzyl-trimethyl ammonium chloride, 4(5)-vinyl imidazole, styrene, acrylamide, vinylpyrrolidone, acrylonitrile, 4-vinyl benzamidine, 2-vinylpyridine, 1-vinylimidazole, acrylamide, methacrylamide, acrylamido-(2-methyl)-1-propane sulfonic acid, itaconic acid, and combinations thereof. By way of illustration, a molecularly imprinted polymer is prepared using divinylbenzene and 4-vinylpyridine or analogues or suitable derivatives thereof as monomers. See, e.g., WO 2009/156763.

The functional monomer may also act as a cross-linking monomer. Suitable non-limiting examples of cross-linking monomers are ethylene glycol dimethacrylate, trimethylolpropane trimethacrylate and divinylbenzene.

In some embodiments, a porogen, preferably in the form of a solvent, is present in a polymerization reaction and leads to the formation of a porous polymer. Suitable porogens are known to a person skilled in the art and non-limiting examples thereof are ethyl acetate, toluene, benzyl alcohol, cyclohexane, isopropanol and acetonitrile. In one embodiment ethyl acetate is used.

A comprehensive study of the behavior of molecularly imprinted polymers with polycyclic aromatic hydrocarbons (Baggiani, et al. (2007) Anal. Bioanal. Chem. 389:413-422), discloses that a molecularly imprinted polymer prepared with chloroform as the porogen has low retention of pyrene in dichloromethane and that the retention gradually increases when increasing amounts of acetonitrile, a high-polarity solvent, was mixed with the dichloromethane. Further, a molecular imprinted polymer prepared with benzo[a]pyrene as the template and dichloromethane as the porogen has been shown to be able to extract benzo[a]pyrene from coffee diluted with methanol (Lai, et al. (2004) Analytica Chimica Acta 522:137-144).

Clay-Based Materials. Clay minerals are one of the most common constituents of soils. Clays are broadly defined as those minerals that make up the colloid fraction (<2 μm) of soils and which may be composed of mixtures of fine-grained clay minerals as well as clay-sized crystals of other minerals (e.g., quartz, carbonates and metal oxides). In a more strict definition, clay minerals are hydrous aluminium phyllosilicates that possess a layered structure. According to the differences in that structure they can be classified as smectites (montmorillonite, saponite), mica (illite), kaolinite, serpentine, pylophyllite (talc), vermiculite and sepiolite. The structure of these minerals features a net negative charge which is balanced by exchangeable cations. These ions can be easily exchanged with cations from a liquid media (Bhattacharyya & Sen Gupta (2008) Adv. Colloid Interface Sci. 140:114-31; Rafatullah, et al. (2010) J. Hazard. Mater. 177:70-80).

The amphiprotic character of silanol and aluminol groups in clays surfaces is responsible for a pH-dependent surface charge in clays. Electrostatic interactions with the surface and mechanisms such as cation exchange, cation bridging with the surface, surface complexation, and hydrogen bonding have been described as being involved in the capture of ionic and polar species from aqueous media (Tolls (2001) Environ. Sci. Technol. 35:3397-3406; Kyziol-Komosinska, et al. (2010) Arch. Environ. Prot. 36:3-14; Klika, et al. (2011) Clay Min. 46:461-71; Pei, et al. (2012) J. Hazard. Mater. 203:137-144; Pereira, et al. (2007) Soil Sci. Soc. Am. J. 71:1476-81). In addition, the interlayer expandability of many of these minerals and the presence of water molecules associated with exchangeable cations in these interlayers allows the exchange of these hydrated ions with much larger organic molecules and their intercalation between the aluminosilicate layers (Klika, et al. (2011) Clay Min. 46:461-71; Li, et al. (2011) J. Colloid Interface Sci. 360:227-232; Sanchez, et al. (2011) Appl. Clay Sci. 53:366-373).

While the hydrophilic characteristics of their surfaces and charges limit the adsorption of anionic, hydrophobic or non-polar organic compounds, the ability of mineral clays to remove non-polar and anionic compounds have been increased by chemical modification. One modification is a simple ion exchange of the natural inorganic interlayer cations with certain organic cations such as quaternary ammonium cations of long hydrocarbon chains. By introducing cationic surfactant molecules into the interlamellar space through ion exchange, the properties of clay minerals are enhanced to those of organoclays (Park, et al. (2011) J. Colloid Interface Sci. 354:292-305; Zhou, et al. (2007) J. Colloid Interface Sci. 311:24-37; Boyd, et al. (1988) Clay Min. 36:125-30). The intercalation of a cationic surfactant between the clay layers changes the surface properties from highly hydrophilic to increasingly hydrophobic. At sufficient loading the surfactant forms a bilayer that results in a reversal of the charge on the external surface of the clay adequate for retention of anions, while neutral species can partition into the hydrophobic core. In addition, modification of a swelling clay with a cationic surfactant results in an increase of the basal spacing of the layer and exposure of new adsorption sites.

As an alternative to the chemical modification of clay surfaces, some studies have employed lightweight clay materials that are based on processed natural clays. The typical form of processing includes thermal treatment that has the effect of causing interlayer hydration water to quickly vaporize with a consequent expansion of the sheet structure of the minerals and formation of pores and channels as the gases escape the softened heated materials. This process yields highly porous materials, with an increased accessible surface area, which can substantially improve the sorbent capacity. Some of the most common processed clay materials that have been used are light expanded clay aggregates (LECA), expanded shale, expanded slate and exfoliated vermiculite. In terms of hydraulic conductivity requirements, particle sizes of these materials can, in general, be obtained in adequate distributions which allow some control of the hydraulic properties of the medium. Various types of clay minerals (kaolinite, illite, montmorillonite, vermiculite, sepiolite, bentonite) have been tested for their ability to remove organic pollutants such as pesticides, PAHs (Pei, et al. (2012) J. Hazard. Mater. 203:137-144; Zhu & Zhu (2011) Fresenius Environ. Bull. 20:521-7; Changchaivong, & Khaodhiar (2009) Appl. Clay Sci. 43:317-321), phenolic compounds (Pereira, et al. (2007) Soil Sci. Soc. Am. J. 71:1476-81) and other aromatics (Pei, et al. (2012) J. Hazard. Mater. 203:137-144). In the vast majority of these studies the organic substances are removed most commonly from pure water solutions in batch adsorption assays.

The method of this invention can be carried out with 1, 2, 3, 4, 5, 6, 7, 8, 9, or more molecular sieves. By way of illustration, liquid smoke can be modified by selecting one molecular sieve to remove benzo[a]pyrene, benzo[a]anthracene, benzo[b]fluoranthene and/or chrysene, and a second molecular sieve to remove all or a portion (e.g., 20-50%) of one or more phenol derivatives thereby providing a liquid smoke of use in food systems as a browning agent. When more than one molecular sieve is used, each of the molecular sieves may be the same type of sieve, e.g., each is a zeolite, activated carbon, molecular imprinted polymer or clay-based material; or each molecular sieve may be different, e.g., one is a zeolite and one is activated carbon. Further, when using more than one molecular sieve, the sieves can be used simultaneously (e.g., as a mixture of molecular sieve particles) or consecutively.

In some embodiments, a molecular sieve is used as a filter such that the food (or smoke) is passed through the filter to remove one or more flavor compounds and optionally toxic compounds from the food. In other embodiments, the molecular sieve is added directly to the food for a sufficient amount of time to remove one or more flavor compounds and optionally one or more toxic compounds. In accordance with the latter embodiment, the molecular sieve can be removed, e.g., by filtration, centrifugation, or sedimentation.

The perception of flavor can involve the integration of multiple flavor compounds, including undesirable flavor compounds; off-flavors; predominant, desirable flavor compounds; minor, desirable flavor compounds; or a combination thereof. Therefore, selective removal of one or more flavor compounds using a molecular sieve can, e.g., alter the flavor profile of a food by removing undesirable flavors or by removing a portion (e.g., 90%, 80%, 70%, 60%, 50%, 40%, 30%, 20%, or 10%) of a desirable flavor compound thereby generating a new or unexpected flavor profile.

Undesirable flavors can be naturally present in a food or be generated during processing. The chemical structure of individual flavor compounds is associated with the chemical reaction that is responsible for its stability. The presence of active functional groups, such as carbonyl, hydroxyl, and thiol functional groups, affects the chemical reactivity of these compounds. Both high- and low-volatility flavor compounds, regardless of whether they are neutral, acidic, or nitrogen- and sulfur-containing compounds, can be susceptible to chemical changes occurring in various kinds of interactions, including oxidation, hydrolysis, thermal degradation, photooxidation, polymerization of unsaturated compounds, and interaction with protein in food systems. For instance, aldehyde can be readily oxidized to acid, amine can form a complex with metal ions, and terpenes are capable of undergoing rearrangement and isomerization under acidic condition. These vulnerable consequences have impacts on the overall flavor quality of food.

Flavor compounds that can be removed in accordance with the present invention include, but are not limited to, ethyl-2-methyl butyrate; vanillin; cis-3-heptenol; cis-3-hexenol; trans-2-heptenal; butyl valerate; 2,3-diethyl pyrazine; methyl cyclo-pentenolone; benzaldehyde; 3,4-dimethoxy-phenol; amyl acetate; amyl cinnamate; γ-butyryl lactone; furfural; trimethylpyrazine; phenyl acetic acid; isovaleraldehyde; ethyl maltol; ethyl vanillin; ethyl valerate; ethyl butyrate; cinnamic aldehyde; ethyl-2-methyl valerate; γ-hexenyl lactone; 2,4-decadienal; 2,4-heptadienal; methyl thiazole alcohol (4-methyl-5-β-hydroxyethyl thiazole); 2-methyl butanethiol; 4-mercapto-2-butanone; 3-mercapto-2-pentanone; 1-mercapto-2-propane; furfural; furfuryl alcohol; 2-mercapto propionic acid; alkyl pyrazine; methyl pyrazine; 2-ethyl-3-methylpyrazine; tetramethylpyrazine; polysulfides; dipropyl disulfide; methyl benzyl disulfide; alkyl thiophene; 2,3-dimethyl thiophene; 5-methyl furfural; acetyl furan; 2,4-decadienal; guiacol; phenyl acetaldehyde; β-decalactone; d-limonene; acetoin; amyl acetate; maltol; ethyl butyrate; levulinic acid; piperonal; ethyl acetate; n-octanal; n-pentanal; n-hexanal; diacetyl; monosodium glutamate; monopotassium glutamate; sulfur-containing amino acids, e.g., cysteine; 2-methylfuran-3-thiol; 2-methyldihydrofuran-3-thiol; 2,5-dimethylfuran- 3-thiol; tetramethylpyrazine; propylpropenyl disulfide; propylpropenyl trisulfide; diallyl disulfide; diallyl trisulfide; dipropenyl disulfide; dipropenyl trisulfide; 4-methyl-2-[(methylthio)-ethyl]-1,3-dithiolane; 4,5-dimethyl-2-(methylthiomethyl)-1,3-dithiolane; and 4-methyl-2-(methylthiomethyl)-1,3-dithiolane, β-ethyl-cinnamaldehyde; eugenol; dipentene; β-damascenone; maltol; ethyl maltol; delta-undecalactone; delta-decalactone; ethyl valerate; ethyl acetate; 2-hexenol-1; 2-methyl-5-isopropyl-1,3-nonadiene-8-one; 2,6-dimethyl-1,6-undecadiene-10-one; 2-ethyl-5-isopropyl acetophenone; 2-hydroxy-2,5,5,8a-tetramethyl-1-(2-hydroxyethyl)-decahydronnaphthalene; dodcahydro-3a,6,6,9a-tetramethyl naphthol(2,1-b) furan; 4-hydroxy hexanoic acid; hexanoic acid; hexadecanoic acid; octadecanoic acid; phenethyl alcohol; dodecylacylate; nerolidol; octanoic acid; oleic acid; linolenic acid; γ-lactone; 2,3-butanedione; 2,3-pentanedione; benzylideneacetone; benzenethiol; dimethylsulfide; 2-ethyl-3,5-dimethylpyrazine; 2,3-diethyl-5-methylpyrazine; 3-hydroxy-2-methylpyridine; 3-hydroxy-6-methylpyridine; 5-hydroxymethyl-2-furfural; 2-phenyl acetamide and 3,5-dihydroxy-6-methy6l-4-pyrone. Flavor molecules can also include amino acids, nucleotides, carbohydrates, and fatty acids. The removal of a particular flavor compound may be dependent upon the food being process. For example, whereas diacetyl is desirable flavor for popcorn seasoning, it imparts and undesirable buttery note to beer.

Toxic compounds are compounds that are known to be harmful to mammals if consumed. Notably, toxic compounds may or may not impart flavor to the food. Toxic compounds include those that cause, e.g., cancer, neurological and behavioral disorders, psychomotor impairments, and visual or hearing impairment. Toxic compounds include, but are not limited to, heavy metals (e.g., arsenic, cadmium, chromium, lead, mercury, nickel, or selenium), perchlorinated biphenyls (PCBs), dioxins, polyaromatic hydrocarbons (PAHs), Bisphenol A (BPA), benzophenones, parabens, organophosphates and organochlorines. PAHs include, e.g., benzo[a]pyrene, benz[a]anthracene, benzo[b]fluoranthene, benzo[j]fluoranthene, benzo[c]fluorene, benzo[k] fluoranthene, benzo[ghi] perylene, chrysene, acenaphthylene, cyclopenta[cd]pyrene, dibenz[a,h] anthracene, acenaphthene, fluoranthene, naphthalene, phenanthreene, pyrene, fluorine, dibenzo[a,e]pyrene, dibenzo[a,h]pyrene, dibenzo[a,i]pyrene, dibenzo[a,l]pyrene, indeno[1,2,3-cd]pyrene and/or 5-methylchrysene.

Suitably, the levels of the one or more toxic compounds are reduced so as to significantly reduce the toxic, e.g., carcinogenic, properties of the food. The method of the invention hence may reduce the level of the one or more toxic compounds by more than 50% compared with untreated food, preferably by more than 80%, more preferably more than 90%, most preferably more than 95%, more than 98% or more than 99%. It is further preferred that the levels of a plurality of the one or more toxic compounds are reduced by these stated amounts. Ideally, the method of the invention removes one or more PAH compounds to the levels set forth in Table 1.

TABLE 1

| | | Maximum Levels |
|---|---|---|
| Food | PAH | (μg/kg) |
| Oils and fats (excluding | Benzo[a]pyrene | 2.0 |
| cocoa butter and coconut | Sum of PAH4 | 10.0 |
| oil) intended for direct | | |
| human consumption or use | | |
| as an ingredient in food | | |
| Cocoa beans and derived | Benzo[a]pyrene | 5.0 μg/kg fat |
| products | Sum of PAH4 | 30.0 μg/kg fat |
| Coconut oil intended for | Benzo[a]pyrene | 2.0 |
| direct human consumption | Sum of PAH4 | 20.0 |
| or use as an ingredient | | |
| in food | | |
| Smoked meat and smoked | Benzo[a]pyrene | 2.0 |
| meat products | Sum of PAH4 | 12.0 |
| Muscle meat of smoked | Benzo[a]pyrene | 2.0 |
| fish and smoked fishery | Sum of PAH4 | 12.0 |
| products, excluding | | |
| fishery products listed | | |
| below. The maximum level | | |
| for smoked crustaceans | | |
| applies to muscle meat | | |
| from appendages and | | |
| abdomen. In case of | | |
| smoked crabs and crab- | | |
| like crustaceans | | |
| (Brachyura and Anomura), | | |
| it applies to muscle | | |
| meat from appendages. | | |
| Smoked sprats and canned | Benzo[a]pyrene | 5.0 |
| smoked sprats (sprattus | Sum of PAH4 | 30.0 |
| sprattus); bivalve | | |
| molluscs (fresh, chilled | | |
| or frozen); heat treated | | |
| meat and heat treated | | |
| meat products sold to | | |
| the final consumer | | |
| Bivalve molluscs | Benzo[a]pyrene | 6.0 |
| (smoked) | Sum of PAH4 | 35.0 |
| Processed cereal-based | Benzo[a]pyrene | 1.0 |
| foods and baby foods for | Sum of PAH4 | 1.0 |
| infants and young | | |
| children | | |
| Infant formulae and | Benzo[a]pyrene | 1.0 |
| follow-on formulae, | Sum of PAH4 | 1.0 |
| including infant milk | | |
| and follow-on milk | | |

PAH4 = benzo[a]pyrene, benz[a]anthracene, benzo[b] fluoranthene and chrysene.

Foods in which the flavor profile can be modified in accordance with the present invention include edible foods or beverages, or precursors or flavor modifiers thereof, as well as a large variety of classes, subclasses and species of dry or liquid additives. Foods processed in accordance with the present invention include, but limited to, bread products including biscuits, crackers, and bread substitutes; pastries; cakes; cookies; breakfast cereals; dairy products such as cheese and processed cheese; soy-based desserts; snacks such as chips/crisps, and pretzels; snack bars such as granola bars, breakfast bars, energy bars, fruit bars, and other snack bars; packaged meal products including slimming products, ready meals, canned ready meals, frozen ready meals, dried ready meals, chilled ready meals, dinner mixes, frozen pizza, chilled pizza, soup, canned soup, dehydrated soup, instant soup, chilled soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, and chilled noodles; oils and fats such as olive oil, vegetable and seed oil, smoked oil (e.g., sunflower or sesame oil), cooking fats, butter, margarine, and spreadable oils and fats; sauces including dressings and condiments, tomato pastes and purees; bouillon/stock cubes; gravy granules; liquid stocks; liquid smoke; herbs and spices and smoked herbs and spices (e.g., Paprika); fermented sauces; soy-based sauces; wet sauces; dry sauces/powder mixes; smoked pastes; ketchup; mayonnaise; mustard; salad dressings; dips; flour; smoked water; smoked sea salt; smoked sugar; smoked dehydrated fruit and vegetables; pickled products; baby food, milk formula; and yeast-based spreads.

Concentrated flavorings, seasonings and additives are of particular use in the method of this invention. Examples of such foods include, but are not limited to, salts, spices, curing mixtures, herbs, condiments, extracts (e.g., chicken, pork or beef extract), synthetic and/or natural flavoring and/or aromatizing preparations (e.g., mushroom extract or cheese powder), ingredients for foodstuffs, maltodextrins, starches, diluent water, acidic liquids such as vinegar, alcohol, edible oils, fats, oil and water emulsions and/or other physiologically unobjectionable solvents or liquids.

The following non-limiting examples are provided to further illustrate the present invention.

### Example 1: Preparation of Liquid Smoke

Wood smoke is a complex and variable mixture of compounds produced during wood pyrolysis, and includes numerous vaporous compounds which are liquids at room temperature. Pyrolysis is a general term for the thermal decomposition of an organic material, such as wood, plants, and fossil fuels, either during combustion or by rapid heating in an oxygen-deleted atmosphere. Pyrolysis with combustion uses the oxidation or burning of a portion of the organic material to provide the thermal energy required to vaporize and decompose the remainder of the organic material. For pyrolysis without combustion, thermal energy is supplied indirectly from an external source, such as radiation, solid or gaseous heat carriers, or thermal conduction through reactor walls. The energy supplied by an external source vaporizes and decomposes the organic material without directly burning the organic material.

The term “liquid smoke” is meant to include any and all liquid media capable of imparting a smoke flavor and/or taste to a comestible product, similar to the flavor and/or taste achieved by direct smoking techniques, when the comestible product is exposed to that liquid medium. For aqueous liquid smoke compositions, production begins with smoke generated by the combustion and/or pyrolysis of wood (e.g., wood chips, wood dust, wood shavings, wood briquettes or logs), charcoal (e.g., briquettes) or other plant material including, but not limited to, Hickory, Mesquite, White Oak, Cherry, Maple, Apple, Beech, Alder, Mulberry, Orange, Pear, Pecan, Plum, Black Walnut, English Walnut, Cedar, Chestnut, barley, malted barley, corn cob, teas, aromatic plants such as rosemary or sage, or mixtures thereof. Notably, in addition to the type of wood, moisture content of the wood and temperature of pyrolysis can be varied to modify the taste profile of the liquid smoke composition. After pyrolysis, the smoke is collected, and can be fed through a column countercurrent to a flow of recirculating water. Alternatively, smoke components can be condensed directly to form a liquid, then water is added to the condensed smoke components. Dilution of condensable smoke components with water by either method results in the separation of undesirable tars, polymers, and other water-insoluble components from the desirable liquid smoke components.

In accordance with this invention, toxic compounds such as PAHs can be removed from liquid smoke either prior to or after condensation of smoke components. By way of illustration, liquid smoke can be prepared by providing smoke; reducing the levels of one or more PAHs in the smoke using a molecular sieve; and condensing the smoke having reduced PAH content to form the liquid smoke. Notably, in this example, PAH reduction can be achieved by passing smoke through a molecular sieve filter or directly adding the molecular sieve to the wood, charcoal or plant material, e.g., at varying amounts of 10%, 20%, 30% or 40%.

Alternatively, liquid smoke can be prepared by providing smoke; condensing the smoke to produce liquid smoke; and contacting the liquid smoke with a molecular sieve to reduce the levels of one or more PAHs in the liquid smoke. Exemplary molecular sieves for removing PAHs from smoke include native clinoptilolite, thermally activated clinoptilolite, and ammonium chloride treated clinoptilolite, which have been shown to remove PAHs such as benzo[a]pyrene. See WO 2015/007742 and Macala et al. (2012) Min. Res. Manag. 28(2):113-123. Ideally, the maximum content of benzo[a]pyrene and benz[a]anthracene in the liquid smoke are 10 ppb (10 μg/kg) and 20 ppb (20 μg/kg), respectively.

While there are numerous different chemical species present in liquid smoke compositions, the water-soluble components of a liquid smoke composition generally are divided into classes based on compounds having distinct functional groups. These classes are acids, carbonyls, phenolics, and basic and neutral constituents. In general, phenolics are the primary flavoring compounds, carbonyls are the primary coloring compounds, and acids are primarily preservatives and pH controlling agents. The acids and carbonyls also make a secondary contribution to flavor and enhance the surface characteristics of smoked foodstuffs. The acids are predominantly C₁-C₄ carboxylic acids, and mainly acetic acid. Acids are measured as titratable acidity calculated as percent acetic acid, by weight.

Similar to toxic compounds, all or a portion of the flavor, color, and/or preservative compounds can be removed from the liquid smoke either prior to or after condensation of the smoke components to impart varying smoke tonalities to flavors or taste systems. The molecular sieve for removing flavor, color, and/or preservative compounds can be the same molecular sieve used in removing toxic compounds or different. Examples of flavor compounds that can be removed from the liquid smoke are listed in Table 2.

TABLE 2
Phenolic Compounds

| | |
|---|---|
| Phenol | 2-methylphenol (o-cresol) |
| 4-methylphenol (p-cresol) | 2-methoxyphenol (Guaiacol) |
| Dimethylphenols | 4-ethylphenol |
| 3-ethylphenol | 2-methoxy-3-methylphenol |
| 2-methoxy-4-methylphenol | 2-methoxy-5-methylphenol |
| 1,2-benzenediol | 3-methoxy-1,2-benzenediol (3- |
| (Pyrocatechol; catechin) | methoxypyrocatechol) |
| 3-methyl-1,2-benzenediol (3- | 4-methyl-1,2-benzenediol (4- |
| methylcatechol) | methylcatechol) |
| 4-ethyl-2-methoxyphenol (4- | 4-methoxy-3-methylphenol |
| ethylguaiacol) | |
| 3-hydroxybenzaldehyde | 4-hydroxybenzaldehyde |
| 2-hydroxybenzaldehyde | 2,6-dimethoxyphenol |
| | (Syringol) |
| Eugenol | Vanillin |
| 4,5-dimethyl-1,3-benzenediol | 2-methoxy-4-propylphenol |
| | (Cerulignol) |
| 4-hydroxyacetyl-2- | 2,6-dimethoxy-4-(2-propenyl) |
| methylphenol | phenol (4-allylsyringol) |
| 4-hydroxy-3- | 4-hydroxy-3,5- |
| methoxybenzeneacetic acid | dimethoxybenzaldehyde |
| | (Syringaldehyde) |

Aldehydes and ketones

| | |
|---|---|
| Propanal | 1-hydroxy-2-butanone |
| 2-methyl-2-cyclopenten-1-one | 1,2-cyclopentanedione |
| 2,5-hexanedione | 4-methyl-2-hydroxycyclopent- |
| | 2-en-1-one |
| 2-hydroxy-3-methyl-2- | 3,4-dimethyl-2-cyclopenten-1- |
| cyclopenten-1-one | one |
| (cyclotene) | |
| 1-(acetyloxy)-2-butanone | 2,3-dimethyl-2-cyclopenten-1- |
| | one |
| 3,4-dimethyl-2- | 3-ethyl-2-hydroxy-2- |
| hydroxycyclopent-2-en-1-one | cyclopenten-1-one |
| 2,3-dihydroxybenzaldehyde | 3,4-dihydroxyacetophenone |
| 1-(3-hydroxyphenyl) ethanone | 2-ethoxy-4-anisaldehyde |
| 1-(4-hydroxy-3- | 1-(4-hydroxy-3,5- |
| methoxyphenyl) ethanone | dimethoxyphenyl) ethanone |
| (Acetovanillone) | (Acetosyringone) |
| 4-hydroxy-2- | 3,5-dimethoxy-4- |
| methoxycinnamaldehyde | hydroxycinnamaldehyde |

Furans and pyrans

| | |
|---|---|
| Furan-3-carbaldehyde | Furan-2-carbaldehyd |
| (3-furfural) | (2-furfural) |
| Tetrahydro-2,5-dimethoxyfura | 1-(2-furanyl)-ethanone |
| | (acetylfuran) |
| Butyrolactone | 2(5H)-furanone |
| 5-methyl-2(5H)-furanone | 5-methyl-2- |
| | furancarboxaldehyde |
| Methyl furan-3-carboxylate | 3-methyl-2(5H)-furanone |
| 2,5-dihydro-3,5-dimethyl-2- | 4-methyl-5H-furan-2-one |
| furanone | |
| Maltol | 5-(hydroxymethyl)-2- |
| | furancarboxaldehyde |

Organic acids

| | |
|---|---|
| Butanoic acid | 2-butenoic acid |
| 3-hydroxy-4-methoxybenzoic | 9-(E)-octadecanoic acid |
| acid | |

Miscellaneous

| | |
|---|---|
| 1,4:3,6-dianhydro-α-d- | 2,3-anhydro-d-mannosan |
| glucopyranose | |
| 1,2,3-trimethoxy-5- | 3-hydroxy-benzoic acid methyl |
| methylbenzene | ester |
| 1,4-dimethoxy-2- | 3-isopropylthiophenol |
| methylbenzene | |
| Vanillic acid methyl ester | 6-hydroxycoumarin |
| 2-propenyl-butanoate | Glycocyanidine |

Examples of molecular sieves of use in removing all or a portion of one or more flavor compounds include, e.g., activated carbon for adsorbing ρ-cresol (Das, et al. (2012) Agric. Eng. Int.: CIGR J. 14(4):37-49) and native or activated bentonite for removing 3-hydroxybenzaldehyde (Koyuncu (2008) Appl. Clay Sci. 38:279-87).

Liquid smoke produced by the method of this invention is subjected to sensory assessment in food compositions, flavors, seasonings, reactions and/or food applications. In addition, flavor of the liquid smoke is compared to other smoke taste/flavor solutions available in the marketplace. Moreover, analytical tests are carried out to determine PAH levels and flavor/taste components. Liquid smoke produced by this method may be used as a single ingredient or in combination with other smoked ingredients (e.g., smoked spices such as smoked paprika).

### Example 2: Smoked Mushroom Extract

Mushrooms are dried and ground to a powder. The mushroom powder may be exposed directly to smoke or subjected to one or more of liquid-liquid extraction, supercritical extraction, distillation, concentration, membrane separation before being exposed to smoke. Smoke can be generated by pyrolysis of wood (e.g., wood chips, wood dust, wood shavings, wood briquettes or logs), charcoal (e.g., briquettes) or other plant material including, but not limited to, Hickory, Mesquite, White Oak, Cherry, Maple, Apple, Beech, Alder, Mulberry, Orange, Pear, Pecan, Plum, Black Walnut, English Walnut, Cedar, Chestnut, barley, malted barley, corn cob, teas, aromatic plants such as rosemary or sage, or mixtures thereof. Notably, in addition to the type of wood, moisture content of the wood and temperature of pyrolysis can be varied to modify the taste profile of the liquid smoke composition. In addition, the smoking time can range from minutes to days. In accordance with this invention, toxic compounds such as PAHs can be removed from the smoke by passing the smoke through a molecular sieve filter or directly adding the molecular sieve to the wood, charcoal or plant material. Accordingly, the ratio of wood to molecular sieve can range from 0% molecular sieve (e.g., zeolite)+100% wood to 95% molecular sieve+5% wood. Similarly, smoke flavors (e.g., phenols, carbonyls, etc.) can be removed from the smoke by passing the smoke through a molecular sieve filter or directly adding the molecular sieve to the wood, charcoal or plant material. Alternatively, or in addition to, all or a portion of one or more mushroom flavors (e.g., 1-octen-3-ol, benzaldehyde, 3-heptanone, isovaleric aldehyde, acetaldehyde, methyl cyclohexanone, phenylacetaldehyde, α-terpineol, benzyl alcohol, etc.) can be removed by contacting the mushroom extract with a molecular sieve. It is expected that all of the above-referenced parameters will have an impact on taste, aroma and/or content of PAHs of the final product.

Any number of mushroom extracts can be smoked including, but not limited to, mushrooms of the genus Boletus, e.g., Boletus edulis, Boletus aestivalis, Boletus hiratsukae Nagasawa, Boletus violaceofuscus, and the like; mushrooms of the genus Amanita, e.g., Amanita hemibapha Amanita caesarea, and the like; Lentinus edodes; Coprinus comatus; Agaricus bisporus.

Smoked mushroom extract produced by the method of this invention is subjected to sensory assessment in food compositions, flavors, seasonings, reactions and/or food applications. In addition, flavor of the smoked mushroom extract is compared to other mushroom extracts available in the marketplace. Moreover, analytical tests are carried out to determine PAH levels and flavor/taste components. Smoked mushroom extract produced by this method may be used as a single ingredient or in combination with other smoked ingredients.

Characteristics of a smoked mushroom extract are presented in Table 3.

TABLE 3
Sensory Data

| | |
|---|---|
| Appearance | Fine powder |
| Color | Yellow to brown |
| Flavor and Odor | Conforms to standard |

Analytic Data

| Moisture % | 0.00 to 4.00 | |
|---|---|---|
| Sieve #20, % through | ≥99.0 | |
| Sieve #40, % through | ≥98.0 | |
| Total Chlorides as NaCl (%) | 0.00 to 3.00 | |
| Benzo[a]pyrene | <10 | ppb |
| Benz[a]anthracene | <20 | ppb |

Microbiological Data

| | |
|---|---|
| SPC | <10000/g |
| B. cereus | <100/g |
| Coliform | <10/g |
| Enterbacteriaceae | <100/g |
| E. coli | Not detected |
| Salmonella | Not detected |
| Yeast and mold | <100/g |
| Staphylococcus aureus | Not detected |
| Thermophilic spores | <10,000/10g |
| Sulfur reducing bacteria | <10/g |

Miscellaneous

| Status | Natural | |
|---|---|---|
| Kosher Requirement | Must be Kosher | |
| Halal Requirement | Must be Halal | |
| Storage conditions | Cool dry area (<21° C.) | |
| Shelf life | 24 | months |

### Example 3: Smoked Cheese Powder

Cheese flavor powder is conventionally produced by macerating a selected cheese or mix of cheeses, rendering in measured amounts of hot water together with various other food grade ingredients, and raising the mix to pasteurizing/emulsification temperatures prior to feeding to a conventional spray drier from which the resultant powder is collected and bagged. Alternatively, cheese flavor can be produced, e.g., via a cultured cheese concentrate (see, e.g., U.S. Pat. Nos. 4,708,876; 6,214,586; or 8,263,144) or a natural biogenerated cheese flavoring system (see, e.g., U.S. Pat. No. 6,406,724).

Independent of the process for preparing the cheese powder, the flavor profile of cheese powder can be further modified by smoking. Smoke can be generated by pyrolysis of wood (e.g., wood chips, wood dust, wood shavings, wood briquettes or logs), charcoal (e.g., briquettes) or other plant material including, but not limited to, Hickory, Mesquite, White Oak, Cherry, Maple, Apple, Beech, Alder, Mulberry, Orange, Pear, Pecan, Plum, Black Walnut, English Walnut, Cedar, Chestnut, barley, malted barley, corn cob, teas, aromatic plants such as rosemary or sage, or mixtures thereof. Notably, in addition to the type of wood, moisture content of the wood and temperature of pyrolysis can be varied to modify the taste profile of the liquid smoke composition. In addition, the smoking time can range from minutes to days. In accordance with this invention, toxic compounds such as PAHs can be removed from the smoke by passing the smoke through a molecular sieve filter or directly adding the molecular sieve to the wood, charcoal or plant material. Accordingly, the ratio of wood to molecular sieve can range from 0% molecular sieve (e.g., zeolite)+100% wood to 95% molecular sieve+5% wood. Similarly, smoke flavors (e.g., phenols, carbonyls, etc.) can be removed from the smoke by passing the smoke through a molecular sieve filter or directly adding the molecular sieve to the wood, charcoal or plant material. Alternatively, or in addition to, all or a portion of one or more cheese flavors (e.g., dimethyl trisulphide, methyl propanethioate, octanol, diacetyl, 3-penten-2-one, 2-heptanone, 2-octanone, 2-nonanone, ethyl acetate, methyl hexanoate, phenol, γ-pentalactone, γ-hexalactone, γ-heptalactone, γ-aminobutyric acid, α-aminobutyric acid, 2,5-dimethyl-5-ethylpyrazine, trimethylbenzene, etc.) can be removed by contacting the cheese powder with a molecular sieve. It is expected that all of the above-referenced parameters will have an impact on taste, aroma and/or content of PAHs of the final product.

Any number of cheese powders can be smoked including, but not limited to, soft cheeses such as cream cheese, Brie and Neufchâtel; semi-soft cheeses such as Havarti, Munster and Port Salut; medium hard cheeses such as Emmental, Gruyere, Gouda, Edam, Jarlsberg, Cantal, Cascaval; semi-hard or hard cheeses such as Cheddar, Colby, Monterey Jack, Parmesan and Pecorino Ramano; and Blue cheeses such as Roquefort, Gorgonzola and Stilton.

Smoked cheese powder produced by the method of this invention is subjected to sensory assessment in food compositions, flavors, seasonings, reactions and/or food applications. In addition, flavor of the cheese powder extract is compared to other cheese powders available in the marketplace. Moreover, analytical tests are carried out to determine PAH levels and flavor/taste components. Smoked cheese powder produced by this method may be used as a single ingredient or in combination with other smoked ingredients.

Characteristics of a smoked cheese powder are presented in Table 4.

TABLE 4
Sensory Data

| | |
|---|---|
| Appearance | Clean powder |
| Color | Cream to Beige |
| Flavor and Odor | Conforms to standard |

Analytic Data

| Moisture % | ≤5.00 | |
|---|---|---|
| Benzo[a]pyrene | <10 | ppb |
| Benz[a]anthracene | <20 | ppb |

Microbiological Data

| | |
|---|---|
| Total aerobic count | <10000/g |
| Enterbacteriaceae | <100/g |
| Yeast and mold | <100/g |

Miscellaneous

| Storage conditions | Cool dark and dry area (10-21° C.) | |
|---|---|---|
| Shelf life | 18 | months |

1. A method for modulating the flavor profile of a food comprising processing the food in the presence of one or more molecular sieves which remove all or a portion of one or more flavor compounds and one or more toxic compounds.

2. The method of claim 1, wherein one or more molecular sieves comprise zeolites, activated carbon, molecular imprinted polymers or clay-based materials.

3. The method of claim 1 wherein the toxic compounds comprise heavy metals, perchlorinated biphenyls (PCBs), dioxins, polyaromatic hydrocarbons (PAHs), Bisphenol A (BPA), benzophenones, parabens, organophosphates or organochlorines.
